(19) United States
(12) Patent Application Publication
(10) Pub. No.: US 2025/0092993 A1
(43) Pub. Date: Mar. 20, 2025

(54) DEVICE FOR RESTORATION OF PRESSURE RETAINING ITEMS SUBJECT TO MATERIAL DEGRADATION

(71) Applicant: PMC Engineering Solutions, Inc., Pottstown, PA (US)

(72) Inventors: Paul Stephen Manzon, Pottstown, PA (US); Nicholas John Koseski, Wexford, PA (US)

(21) Appl. No.: 18/888,960

(22) Filed: Sep. 18, 2024

Related U.S. Application Data
(60) Provisional application No. 63/539,223, filed on Sep. 19, 2023.

(51) Int. Cl. F17C 1/04; F16L 55/16

(52) U.S. Cl. CPC F17C 1/04; F16L 55/1608; F17C 2203/012; F17C 2203/0692; F17C 2209/221; F17C 2209/232

(57) ABSTRACT

A device for restoration by encapsulation of a breached, leaking, or degraded pressure retention item. The apparatus may include multiple features for reducing loads on the pressure retention item, including a filler or liner plate, filler material, and an angled attachment point between the apparatus and the pressure retention item. The apparatus may include inspection ports for viewing, pressure, or leak detection. The apparatus may include a guide track for improved welding to fasten the apparatus to the pressure retaining item. The apparatus may include an expansion joint or bellows, allowing lateral and/or axial movement of the device and/or the pressure retaining item.

### BACKGROUND OF THE DISCLOSURE

### 1. Field of the Disclosure

This disclosure relates to devices and methods for restoring degraded pressuring retaining items.

### 2. Description of the Related Art

Pressure retaining parts of pressure retaining items may be subjected to material degradation (where degradation is defined as a change in state from that of its original construction to the extent that an item that is identified as degraded is not capable of meeting one or more intended purposes). Degradation of material may include thinning of a material (metal loss), cracks forming within or upon the surface of a material, pitting of a material, or general overall structural damage in a material. Degradation of a material may be caused by, but is not limited to, erosion, corrosion, or chemical reactions between the fluid contained by a pressure retaining item and its material of construction. Degradation of a material, including material geometrical changes or changes in a material physical property including but not limited to changes in material yield strength, tensile strength, modulus of elasticity, etc., may be caused by an imposed load, pressure, or temperature condition. Material degradation can be global (by global it is meant that essentially the entirety or a large portion of the materials of construction of a pressure retaining item are subjected to material degradation). Alternatively, material degradation can be local (by local it is meant that a small amount of the total materials of construction of a pressure retaining item is subjected to material degradation). Either global or localized material degradation can result in 1) a condition of non-compliance with that criteria (Codes and Standards of construction, and applicable design and operating conditions for which a pressure retaining item was originally designed, certified, and required to be in compliance with at all times), or 2) a potentially hazardous condition wherein as-designed and constructed safety factors against fluid leakage or pressure retaining item structural integrity or pressure retaining item pressure boundary pressure retention capability is reduced. In severe material degradation conditions (either global or local), failure of pressure retaining items can occur. Non-compliance of a pressure retaining item with the criteria for which a pressure retaining item is certified to be in compliance with most often will result in the pressure retaining item having to be removed from service and thus resulting in economic losses. Pressure retaining item failure can result in affecting the safety of personnel and/or in economic losses.

To obtain information pertaining to material degradation occurring in pressure retaining items, periodic inspections of pressure retaining items are performed. Inspection methods include visual inspection for observation of material degradation or visual inspection for observation of fluid leakage. Inspection methods also include pressure retaining item material of construction thickness measurements for determination of material degradation (metal loss). Thickness measurements can be obtained using various data collection and nondestructive examination methods including but not limited to physical measurements using various gages or measuring instruments or by performing ultrasonic examination to obtain material condition and thickness information.

When material degradation is determined, assessments of remaining life and adequacy of pressure retaining items to remain in service while continuing to operate within the requisite factors of safety are performed. If it is determined that a specific pressure retaining item does not have the requisite factor of safety to continue operation, several options are available to support continued safe operation, including 1) changing the conditions under which that specific pressure retaining item is operated to conditions that are acceptable for continued safe operation, or 2) performing replacement, repair, or restoration of unacceptable parts of pressure retaining items.

Common methods of repair include removal of a degraded material section determined to be unacceptable and replacement with a new section of material of equivalent or better structural, pressure retaining, corrosion resistance, and/or erosion resistance than that used in the original construction. New sections of replacement material are most often installed by joining them to an existing pressure retaining item at locations with adequate material thickness for continued operation of the item. The new sections of replacement material are most often joined to the existing pressure retaining item using complete joint penetration welds. This type of restoration may be referred to as a “flush patch repair”.

A different type of repair used where a section of material degradation may be localized is referred to as a “weld build-up repair”. A “weld build-up repair” is a repair method wherein weld metal is deposited onto either side of the degraded pressure retaining material surface (pressure side or non-pressure side) to increase the thickness and strength of the pressure retaining item in the area of unacceptable material, to return the degraded area to a condition wherein the pressure retaining item can be returned to service under a specific set of operating conditions.

Another method of repair, referred to as a “fillet welded patch plate”, may or may not be allowed by jurisdictional requirement depending on what Codes and/or Standards apply to the pressure retaining item. In this type of repair, a section of new material is fitted over a local area of a specific pressure retaining item at the location of degraded material and joined to the surface of that specific pressure retaining item using a fillet weld. This method of repair does not readily allow for volumetric examination of the attachment fillet weld, future thickness verifications of the underlying pressure retaining material, pressure integrity examination of underlying degraded pressure retaining material, or otherwise verification of the pressure integrity, by examination, of the fillet weld joint. For these reasons, the completed repair may result in a smaller factor of safety than either a “flush patch repair” or “weld build-up”repair”.

“Flush patch repair” and “weld build-up repair” methods of repair or restoration of a pressure retaining item containing areas of degraded material are generally allowed by governing Codes and Standards for construction, operation, or inspection, and are also generally allowed by most jurisdictional authorities (Government, State, Commonwealth, or City) in the United States. “Flush patch repair” and “weld build-up repair” methods of repair allow for a volumetric examination and pressure integrity examination of the material, weld build-up, and attachment welds used in a repair or restoration. When appropriately implemented, a “flush patch repair” method typically results in equal pressure retention and structural integrity factors of safety to those that existed at the time of original construction. Whereas the “weld build-up repair” method may, but do not always, result in pressure retention and structural integrity factors of safety that are equal to or greater than those that existed at the time of original construction or when the repair was implemented.

“Flush patch repair” or “weld build-up repair” methods for repair of pressure retaining items have several limitations or negative aspects. The “flush patch repair” method has limitations or negative aspects including but not limited to: (1) as there is no change in the mechanism(s) that caused the degradation, the rate of degradation in the adjacent existing material and new replacement material will typically be greater than that of the material being replaced as the process of welding in the new replacement material results in local heat affected zones in the weld and causes both the adjacent existing and new replacement material to provide a reduced level of protection from the degradation mechanism(s), (2) where new replacement material is either lined or clad with a material that provides protection against material degradation, the lining or cladding material is typically not flush with adjacent existing material and this non-flush configuration causes a localized change in fluid dynamics that can result in a higher rate of degradation in the attachment weld and material adjacent to the weld than that which existed in the degraded material that is being replaced, (3) this method requires removal of the pressure retaining item from service, (4) this method requires cutting out of pressure retaining item local to area of degraded material, (5) this method requires FME (foreign material exclusion) control during removal (cutting out) of the degraded material, (6) this method requires configuration of the new replacement material (in post formed condition) to be an exact match to the degraded material cutout, (7) this method requires a minimum thickness of existing material at the periphery of the area that is cut out, (8) this method requires weld preparation configuration (by cutting, grinding, or machining) at periphery of area that is cut out for welding in of the new replacement material, (9) this method requires consideration in selecting new replacement material, which may have different material properties, impacting the structural integrity, pressure retention, and material resistance of the pressure retaining item to the application degradation mechanism(s) (strength, welding, low temperature impact resistance, post weld heat treatment, thermal expansion, galvanic corrosion, flow assisted corrosion, fatigue resistance, etc.), (10) for a cylindrical pressure vessel or shaped pressure vessel head this method requires the new material to be curved (in one or two directions) to a configuration, that matches the existing cut out material, by rolling, forming, or machining and additionally, the configuration is required to have weld end preparations of the new material made for exact fit-up to removed degraded material cut out configuration, (11) this method requires, for most repairs, that new material attachment welds be made without use of backing strips as use of backing strips reduces the structural and pressure retention factors of safety at the attachment weld location (e.g. lower weld joint efficiency factors must be applied by most Codes and Standards when computing maximum allowable stresses) and can result in localized fluid dynamic changes that can significantly increase the rate of degradation (through erosion and/or corrosion mechanisms) at the weld and in the existing and new materials local to the attachment weld. (12) this method may require implementation of protective methods to deal with potential exposure of personnel to lethal or hazardous fluid contents of a pressure retaining item, such as high temperature fluid, chemicals, gases, or radioactive fluid contents, during and following removal of degraded material, (13) as the method requires cutting of the pressure retaining item, this method introduces the potential for damage to internal parts of pressure retaining items such as damage to internal tubes in heat exchangers.

The use of these types of material configurations typically introduces new issues with respect to future degradation. While lined or clad new replacement material does not change the mechanism that caused the original degradation, it can introduce a configuration change at the periphery of the lining or cladding that changes the process fluid flow pattern (flow changes in laminar, turbulent, and a transition region flows) at the location of the configuration change and associated existing to new replacement material weld attachment location. These flow pattern changes, along with welding heat effects on the weld and adjacent materials can significantly increase the rate of material degradation at the existing to new replacement material weld attachment location, (14) use of this method, with jurisdictional application of Codes and/or Standards, often requires hydrostatic or pneumatic testing of a pressure retaining item following implementation of a “flush patch repair” to ensure pressure retaining integrity has been maintained, (15) use of this method, with jurisdictional application of Codes and/or Standards, typically requires volumetric examination (radiography or ultrasonic examination) of new replacement material to existing material attachment welds, and (16) this method typically requires additional structural supports to be added to the pressure retaining item during repair as removal of a degraded section of the item being repaired can result in an unstable structural condition of the item.

The “Weld build-up repair” method has limitations or negative aspects including but not limited to: (1) the governing Code and/or Standard allowance, depending on jurisdictional authority requirements, for use of this method can be limited to application of weld build-up on only the side of existing material that is degraded, (2) this method is only practical to, and typically limited to, small area repairs as large areas of “weld build-up repair” can result in weld cracking or distortion of pressure retaining item due to weld shrinkage and both mechanisms potentially further degrade the pressure retaining item, (3) Codes and Standards typically require volumetric examination (radiography or ultrasonic examination) of the weld build-up area, (4) the governing Codes or Standards allowance, depending on jurisdictional authority requirements, typically has maximum thickness limitations on the extent of the weld build-up this can render the method unsuitable for the application or it can limit future operating life following repairs.

Another method that may be used is encapsulation of the degraded pressuring retaining item as discussed in a prior art (U.S. Pat. No. 6,860,297), where a new pressure chamber is used to encapsulate a localized area of degraded material, allowing for repair without the need to remove the degraded material (does not require breach of the pressure boundary of the item) and/or require taking the pressure retaining item out of service.

Shortcomings of the prior art device and method include but are not limited to: (1) the inability to perform visual inspection, monitoring of encapsulation (interstitial) cavity conditions (e.g. pressure, temperature, identification of breach of the degraded pressure retaining item's original pressure boundary after installation of the prior art device), or otherwise directly or physically access the degraded area after restoration by encapsulation thus making the encapsulated area effectively rendered inaccessible, (2) the prior art device, having a hub that is essentially perpendicular to the surface of the degraded pressure retaining item, causes increased localized loading stresses on the periphery of the restored area, (3) this method does not intrinsically lend itself to automated welding for installation and is typically manually welded to the degraded pressure retaining item, (4) the cavity constructed between the hub and the original surface of the pressure retention item creates a potential for trapping process fluid, or otherwise inhibiting process fluid exchange, in the event of breach of the pressure boundary of the pressure retaining item after the encapsulation of the degraded area which can limit the ability to drain the pressure retaining item efficiently and completely in the future, if it is required to be drained, and additionally, stagnation of the fluid in this cavity can have negative effects on the chemical makeup of the process fluid within the volume and as such potentially resulting in exchange of this stagnated fluid with the process fluid which can cause non-homogenous chemical distribution of the process fluid, and additionally, trapping or otherwise inhibiting process fluid exchange between the cavity and a breached pressure retaining item can cause hazardous (chemically, radiologically, or other) process fluid to be trapped within the cavity and limit the ability to effectively or safely remove it in the future in a controlled fashion, (5) the prior art device does not mechanically attach or otherwise support the entire degraded area of the pressure retaining item in the area beneath the encapsulation and thus stresses cannot be transferred from this area to the prior art device to enhance the strength of the repair, whereas the degraded area will continue to degrade in the future, the prior art device does not effectively provide a means to limit or eliminate the potential for pieces of the degraded area falling off the surface of the pressure retaining item such that pieces falling off may enter the process side of the degraded pressure retaining item and may cause detrimental effect to the restored system or systems associated with the process involved in the pressure retaining item's application (e.g. pieces may fall off and be carried through the pressurized system and damage pumps, generators, or other process equipment), (6) the prior art device, due to its rigid construction, has an intrinsic inability to accommodate expansion or contraction of the degraded pressure retaining item after installation such that it will not function as an expansion joint and cannot be used to perform restoration on an existing expansion joint as it would eliminate the functional degrees of freedom for movement of an encapsulated expansion joint, (7) the prior art device, when employed on the surface of a pressure retaining item that is in contact with fluid, gas, or other media flow, having hubs that are essentially perpendicular to the surface of the degraded pressure retaining item (oriented perpendicular to the direction of process media flow), drastically interrupts flow of the system and causes turbulence which could negatively affect the item, the item's function, or the system for which the degraded pressure retaining item functions within.

What is needed is a device for restoring degraded pressure restraining items that provide one or more of the benefits including: (1) having a removable inspection port that allows for visual inspection, monitoring of cavity conditions, or otherwise direct access to the encapsulated area of the degraded pressure retaining item after installation of the device, (2) providing for reduction of/or elimination of cavity empty volume through the addition of material within the cavity by the addition of a filler material and/or a reinforcing plate, (3) adding reinforcement and/or a protective barrier to the device, and the restored pressure retaining item by addition of material within the cavity constructed by the encapsulation, where additional material within the cavity provides a structure to support the degraded area of the pressure retaining item as it continues to degrade in service, and having additional material within the cavity that transfers stresses from the pressure boundary of the pressure retaining item, in the area of degradation, to the prior art device thus enhancing the strength of the restored pressure retaining item as well as the strength of the prior art device, (4) provide for reduced localized loading stresses on the periphery of the restored area by resolving those forces at the device to degraded pressure retaining item interface through device hubs that are not essentially perpendicular to the surface and where resolving transferred forces in directions not essentially perpendicular to the surface of the degraded pressure retaining item reduces the forces acting on the perpendicular vector, thus decreasing the moment applied to the surface of the pressure retaining item, (5) reducing or essentially eliminating empty space within the cavity constructed by the device between the device and the encapsulated area of the degraded pressure retaining item, with the addition of fluid-filled and subsequently hardened filler media (e.g. epoxy, reactive polymer, grout, concrete, etc.) by the addition of this filler material (with or without adhesive properties) which may also be used with or without rigid embedment anchors (anchor studs, machined profiles serving as anchors, etc.) attached to the encapsulation device and/or to the surface of the degraded pressure retaining item that once installed will mechanically attach the degraded area of the pressure retaining item to the device, (6) providing an integrated welding track facilitating automatic welding equipment attachment and guidance to the device in order to facilitate the performance of automated welding techniques to weld attach the device to the degraded pressure retaining item, (7) providing for process-intended expansion and/or contraction of the degraded pressure retaining item (e.g. a mechanical pressure retaining expansion joint) through incorporation of physical configurations of the device that accommodate mechanical expansion and/or contraction, (8) reducing the disturbance to fluid flow dynamics within a pressure retaining fluid-flow system, when the device is attached internally (on the pressure-side of the degraded pressure retaining item, through employing a device profile with hubs that are not substantially perpendicular to the surface of the degraded pressure retaining item, and having an angled profile on the periphery of the device that provides for more laminar, less turbulent, flow within a fluid system, past the device.

### BRIEF SUMMARY OF THE DISCLOSURE

The devices and methods disclosed herein are technically advantageous because they creates alternative ways to restore degraded pressure restraining items. Specifically, various configurations may be secured over a degraded pressure retaining area to provide one or more of: improved integrity, visual inspection capability, pressure monitoring, breach alerting, mechanical stress reduction, improved welded installation methods, application of expansion and contraction capabilities, and decreased impact to the functional properties of the degraded pressure retaining item for which it is applied to. Other technical advantages will be apparent to those of ordinary skill in the art in view of the following specification, claims, and drawings.

One embodiment according to the present disclosure includes a device for encapsulating at least a portion of a pressure retaining item, including: a shell having an inner surface and an outer surface; a hub proximate to a perimeter of the shell that extends substantially perpendicular from the inner surface, wherein the hub has an edge configured to be integrally attached to the pressure retaining item and surround a portion of the pressure retaining item; wherein the hub is configured to be integrally attached by complete joint penetration (CJP) fusion welding to form a complete coalescence of metal of the hub and the pressure retaining item and form a cavity between the pressure retaining item and the device when integrally attached; and a filler plate attached to the inner surface of the device. The filler plate may be configured to not completely fill the cavity when the device is attached to the pressure retaining item.

Another embodiment according to the present disclosure includes a device for encapsulating at least a portion of a pressure retaining item on one side, including: a shell having an inner surface, an outer surface and an opening; and a hub proximate to a perimeter of the shell that extends substantially perpendicular from the inner surface, wherein the hub has an edge configured to be disposed integral with the pressure retaining item and surround a portion of the pressure retaining item; wherein the hub is configured to be integrally attached by complete joint penetration (CJP) fusion welding to form a complete coalescence of metal of the hub and the pressure retaining item and form a cavity between the pressure retaining item and the device when integrally attached; and wherein the shell has at least one opening extending from the inner surface to the outer surface. The device may include at least one of: an inspection plate and an access plate disposed on the outer surface of the shell and covering the opening; a plurality of bolts configured to fasten the at least one of the inspection plate and the access plate to the shell; and at least one of an o-ring and a gasket disposed between the shell and the at least one of the inspection plate and the access plate. The at least one of the inspection plate and the access plate may include an inspection window. In some embodiments, the at least one of the inspection plate and the access plate may include a physical access port configured to receive a monitoring device. In some embodiments, the at least one opening may include a physical access port configured to receive a monitoring device.

Another embodiment according to the present disclosure includes a device for encapsulating at least a portion of a pressure retaining item on one side including: a shell having an inner surface and an outer surface; and a raised hub disposed proximate to a perimeter of the shell that extends from the inner surface to an outer surface of the pressure retaining item at an angle of incidence, wherein the hub has an edge configured to be integral with the pressure retaining item and surrounds a portion of the pressure retaining item; wherein the hub is configured to be integrally attached by complete penetration fusion welding to form a complete coalescence of metal of the hub and the pressure retaining item and form a cavity between the pressure retaining item and the device when integrally attached; and wherein the angle of incidence of the hub is not substantially perpendicular to the surface of the pressure retaining item. The angle of incidence may be acute.

Another embodiment according to the present disclosure includes a device for encapsulating at least a portion of a pressure retaining item on one side, including: a shell having an inner surface and an outer surface; a hub proximate to a perimeter of the shell that extends substantially perpendicular from the inner surface, wherein the hub has an edge configured to be integrated with the pressure retaining item and surround a portion of the pressure retaining item, wherein the hub is configured to be integrally attached by complete penetration fusion welding to form a complete coalescence of metal of the hub and the pressure retaining item and form a cavity between the pressure retaining item and the device; and a guide track disposed on the outer surface proximate to the perimeter of the pressure maintenance shell and configured to receive one of: an automated welding device and a semi-automated welding device. In some embodiments, the device may include the one of: the automated welding device and the semi-automated welding device.

Another embodiment according to the present disclosure includes a device for encapsulating at least a portion of a pressure retaining item on one side including: a shell having an inner surface and an outer surface; and a hub disposed proximate to a perimeter of the shell that extends substantially perpendicular from the inner surface, wherein the hub has an edge configured to be integrated with the pressure retaining item and surround a portion of the pressure retaining item; wherein the hub is configured to be integrally attached by complete joint penetration (CJP) fusion welding to form a complete coalescence of metal of the hub and the pressure retaining item and form a cavity between the pressure retaining item, the shell, and the hub; and an injectable filler material disposed in the cavity; at least two openings in the shell extending between the inner surface and the outer surface; and at least two caps disposed on the at least two openings. The device may also include a plurality of filler anchors disposed on at least one of: the inner surface of the pressure maintenance device and the outer surface of the pressure retaining item in the area of encapsulation. The filler material may completely fill the cavity between the device and the pressure retaining item.

Another embodiment according to the present disclosure that includes a device for encapsulating a portion of a pressure retaining item on one side including: a shell having an inner surface and an outer surface with a port between the inner surface and the outer surface; and a hub proximate to a perimeter of the shell that extends substantially perpendicular from the inner surface, wherein the hub has an edge configured to be integral with the pressure retaining item and surround the portion of the pressure retaining item; wherein the hub is configured to be integrally attached by complete joint penetration (CJP) fusion welding to form a complete coalescence of metal of the hub and the pressure retaining item and form a cavity between the pressure retaining item and the device; and a monitoring device disposed in the at least one port. The monitoring device may include one or more of: a pressure gauge, a temperature sensor, a fluid detector, a pressure activated whistle, and a thickness measuring device.

Another embodiment according to the present disclosure includes a device for encapsulating at least a portion of a pressure retaining item on one side, comprising: a shell having an inner surface and an outer surface; and a hub proximate to a perimeter of the shell that extends substantially perpendicular from the inner surface, wherein the hub has an edge configured to be integral with the pressure retaining item and surround the portion of the pressure retaining item; wherein the hub is configured to be integrally attached by complete joint penetration (CJP) fusion welding to form a complete coalescence of metal of the hub and the pressure retaining item and form a cavity between the pressure retaining item and the pressure maintenance device; and wherein at least a portion of the shell includes an expansion joint.

### BRIEF DESCRIPTION OF THE DRAWINGS

A better understanding of the present disclosure can be obtained with the following detailed descriptions of the various disclosed embodiments in the drawings, which are given by way of illustration only, and thus are not limiting the present disclosure, and wherein:

FIG. 1 is a diagram of a cross-section view of a prior art device, installed on a degraded area of a pressure retaining item; of which the device, according to the embodiments of the present disclosure, enhances through one or more additional features.

FIG. 2 is a diagram of a cross-section view of a device installed on a degraded pressure retaining item, sharing many similar attributes of the prior art device depicted in FIG. 1 but with the addition of a filler or liner plate on the device, according to the embodiment of the present disclosure.

FIG. 3 is a diagram of a cross-section view of a device installed on a degraded pressure retaining item, sharing many similar attributes of the prior art device depicted in FIG. 1; but with the addition of a removable/replaceable inspection plate or access plate on the device, according to the embodiment of the present disclosure.

FIG. 4 is a diagram of a cross-section view of a device installed on a degraded pressure retaining item, sharing many similar attributes of the prior art device depicted in FIG. 1; but with angled hubs that are not substantially perpendicular to the surface of the degraded item's surface, according to the embodiment of the present disclosure.

FIG. 5A is a diagram of a cross-section view of a device installed on a degraded pressure retaining item, sharing many similar attributes of the prior art device depicted in FIG. 1 but with an integral guide track for use with automated or semi-automated welding equipment, according to the embodiment of the present disclosure.

FIG. 5B is a diagram of a top view of the device shown in FIG. 5A, with a guide track for use with automated or semi-automated welding equipment.

FIG. 6 is a diagram of a cross-section view of a device installed on a degraded pressure retaining item, sharing many similar attributes of the prior art device depicted in FIG. 1; but with an injectable filler material occupying the interstitial cavity constructed between the device and the surface of a degraded pressure retaining item, according to the embodiment of the present disclosure.

FIG. 7 is a diagram of a cross-section view of a device installed on a degraded pressure retaining item, sharing many similar attributes of the prior art device depicted in FIG. 1; but incorporating a cavity environment monitoring device or breach indicator on the device, according to the embodiment of the present disclosure.

FIG. 8A is a diagram of a cross-section view of a device installed on a degraded pressure retaining item, sharing many similar attributes of the prior art device depicted in FIG. 1; but the device also includes an expansion joint for use in encapsulating a degraded pressure retaining item that includes an expansion joint, according to the embodiment of the present disclosure.

FIG. 8B is a diagram of a cross-section view of a device installed on a degraded pressure retaining item, sharing many similar attributes of the prior art device depicted in FIG. 1; but the device also includes an expansion joint for use in encapsulating a degraded pressure retaining item that is rigid (non-bellows), according to the embodiment of the present disclosure.

### DETAILED DESCRIPTION OF THE DISCLOSURE

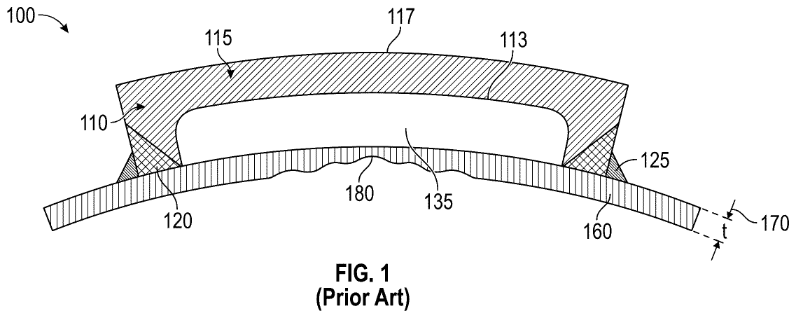

FIG. 1 shows a cross-section view of a prior art device 100 installation on a surface of a degraded pressure retaining item wall 160 (such as a pressure vessel or pipe). The pressure retaining item wall 160 has an as-constructed thickness 170 and shows a degraded portion of the wall 180 where the thickness 170 has been reduced due to various mechanisms of material loss (degradation) in application. The installed prior art device 100 includes a hub 110 that is substantially perpendicular to the surface of the pressure retaining item 160 on which it is installed. Herein, the term “hub” is used for a wall or skirt that extends from the perimeter of a shell or plate to form an interior space, such as a bowl. The hub 110 exists around the entire periphery of the prior art device, machined and/or formed to a geometry allowing for the encapsulation of reduced thickness area 180 of the pressure retaining item wall 160. When installed, the prior art device 100 forms a cavity 135 between the device 100 and the pressure retaining item wall 160, and provides a new pressure maintenance boundary, supplementing and/or replacing the degraded pressure retaining item wall 160, in order to provide for increased pressure retaining item lifespan and/or continued Code and/or Standard compliance. The prior art device 100 encapsulates the degraded area 180 of the pressure retaining item wall 160. The prior art device 100 has a shell 115 with an inner surface 113 and an outer surface 117. The prior art device's geometry has a “hub” (raised section) 110 oriented substantially perpendicular to the surface of the degraded pressure retaining item wall 160 where the hub 110 that makes direct contact or close-fitted contact with the pressure retaining item wall 160. The hub 110 is secured to the pressure retaining item wall 160 by a complete joint penetration weld 120 that may be additionally structurally reinforced by a fillet weld 125. The hub 110 and the shell 115 may be parts of a unified component.

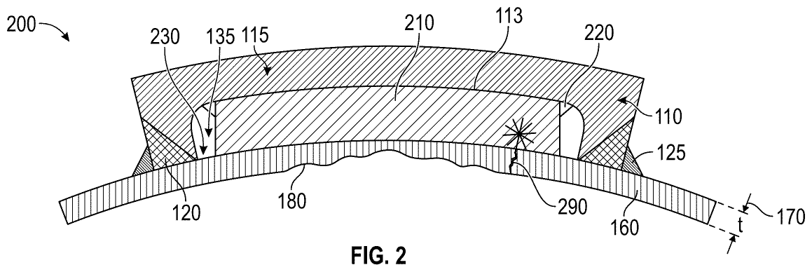

FIG. 2 shows a cross-section view of the device 200 on the degraded pressure retaining item wall 160 according to an embodiment of the present disclosure. The device 200 may include many of the elements of the prior art device and its installation 100 (FIG. 1). The hub 110 and the shell 115 may be separate parts joined, welded, or otherwise fastened together or different aspects of a single component, as would be understood by a person of skill in the art. The device 200 may include a filler or liner plate 210 installed between the inner surface 113 and the pressure retaining item wall 160. The filler or liner plate 210 may be made of steel, epoxy, carbon fiber reinforced composite or polymetric material, Kevlar®, polymer, ceramic, or non-ferrous metal. The filler or liner plate 210 may or may not fill the entirety of the interstitial cavity 135 constructed between the inner surface 113 of the device shell 115 and the degraded pressure retaining item wall 160. The filler or liner plate 210 may occupy the majority of the volume of the interstitial cavity 135; however, a reduced cavity 230 may remain near or at the edge of the hub 110. The reduced volume cavity 230 may be the same shape or different from the shape of the device 200. Just as the device 200, the filler or liner plate 210 is not limited to a specific geometrical shape. It may be constructed to any regular or irregular shape including but not limited to round, square, rectangular, obround, oval, triangular, or any combination of these shapes.

The filler or liner plate 210 may be affixed to the device 200 by a weld 220 (in the case of a metallic filler plate or liner plate), or by mechanical means (bolted or otherwise fastened) or by adhesive (glued, epoxy bonded, or similar (as in the case of a non-metallic filler or liner plate)). The weld attaching a metallic filler or liner plate may continue around the full perimeter of the filler plate 210 and/or plug welds may be used to attach the filler or liner plate to the device 200.

During operational service, the pressure retaining item sustains a pressure load on the pressure boundary material (wall 160). If a degraded area 180 forms in or on the wall 160, the wall's ability to sustain the pressure load is diminished and a repair or restoration is necessary to continue safe operation. When the device 200 is used as the means for restoration, the majority of the pressure load on the area where the device 200 is installed is transferred from the pressure retaining item wall 160 through the device 200, with a small or no load being transferred through the area of degraded pressure retaining item wall 180 encapsulated by the device 200. In the prior art device 100 (FIG. 1) loads are transferred to the prior art device 100 (FIG. 1) at the point of attachment 120 to the prior art hub 110 only. The presence of a filler plate 210, which is in contact with the pressure retaining wall 160 and the inner surface 113 of the device shell 115, allows for diversion of some of the loading to be transferred to the device 200 over a greater area of load application (contact area), resulting in less stress concentration at the point of device 200 attachment in both the pressure retaining item's wall 160 and the device 200. This produces a more robust pressure boundary restoration. Additionally, the filler plate 210 increases the structural rigidity of the device 200 as the filler plate 210, being mechanically attached to the device shell 115, adds more material to the device 200, allowing it to sustain higher loads. Where the filler plate 210 is in contact with the surface of the encapsulated area 180 of the pressure retaining item, significantly more load is transferred through the encapsulated portion of the pressure retaining item than when it is not in contract with the surface of the pressure retaining item. A more robust load/stress capacity restoration can be accomplished because of the reduction of local load transfer through the hub 110 of the device 200, thus reducing the required local thickness of the device 200 and the pressure retaining item area in the periphery area of application of the device 200, providing for a more cost-effective restoration to be accomplished as the size of the device 200 and/or area of encapsulation on the pressure retaining item being restored may be reduced. The addition of the filler plate 210 may also allow for an increase in the load capacity of the device 200 and thus provide an increased factor of safety.

Reduction of the interstitial cavity 135 empty volume may also reduce stagnated fluid volume in the event of a breach to the degraded pressure retaining item wall 160. This precludes the effects of stagnated fluid on the chemistry of the fluid or gaseous system for which the original pressure retaining system operates. Stagnation can cause particulate settlement and heterogeneous fluid composition which could affect the performance of the process system or entrapment of hazardous particulate matter (e.g., radioactive particulate matter). This configuration may also cause a reduction of turbulation or the potential for jetting of fluid through a potential breach 290 in the degraded pressure retaining item's wall 160 occurring within the encapsulated interstitial cavity 135, both of which could damage the device 200 or the application system through erosion and/or corrosion mechanisms. This also reduces the effect of a breach 290 on the fluid dynamics of the pressure retaining item's system, where heterogeneous pressure differentials within the system could damage the application equipment. This existence of a filler or liner plate 210 can also reduce the potential wear on the device 200 itself as it serves as a liner plate 210 protecting the device inner shell surface 113 of the device 200 that performs the pressure retention function in application, providing for a longer lifespan for the device 200 in the event that a breach to the degraded pressure vessel wall 290 exposes the device 200 to an erosive or corrosive environment.

The device 200 may be prepared by disposing the filler or liner plate 210 to the inner shell surface 113 and fastening it with the weld 220. Then, the hub 110 and the shell 115 are disposed on the pressure retaining wall 160 in a position where the reduced thickness area 180 and/or the potential breach location 290 are covered by the shell 115 to form the reduced volume cavity or cavities 230 The hub 110 is then attached to the wall 160 with the complete joint penetration weld 120. In some embodiments, the optional fillet weld 125 may be applied between the complete joint penetration weld 120 and the wall 160.

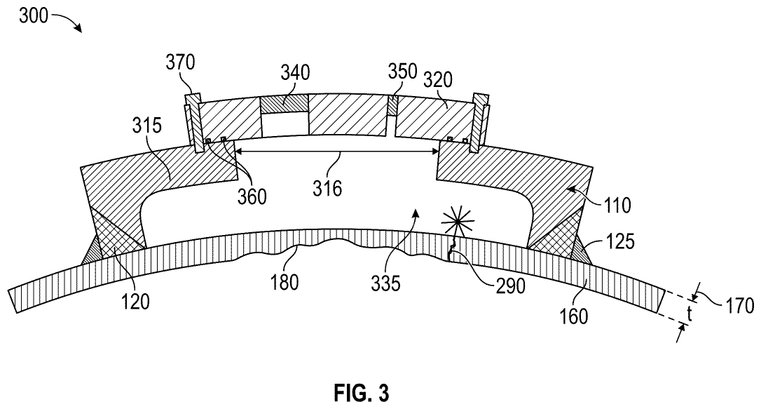

FIG. 3 shows a diagram of a cross-section view of the device 300 dimensioned for attachment to the pressure retaining item wall 160 according to another embodiment of the present disclosure. The device 300 includes several elements of the prior art device 100 (FIG. 1) (it is of metal construction, dimensioned to fit over a degraded area of the pressure retaining wall 180 and/or breach 290 in a degraded pressure retaining item); however, the device 300 also includes an opening 316 in the shell 315. The opening 316 may be dimensioned to receive an inspection plate or access plate 320. The inspection plate or access plate 320 combined with the device shell 315 and hub(s) 110 form an interstitial cavity 335, capable of pressure retention when integrally attached to the pressure retaining item wall 160. The inspection plate or access plate 320 may include one or more ports 350 for observing, monitoring, or otherwise granting access to, witnessing, or facilitating intervention ability with the conditions within the interstitial space 335 when the device 300 is installed on the degraded pressure retaining item wall 160. In some embodiments, one of the one or more inspection plate or access plates 320 may include a transparent window 340 for visual inspection of the encapsulated degraded pressure retaining item wall 160 including (if present) areas of reduced thickness 180 and/or areas of breach 290 and the interstitial cavity 335 after installation. In some embodiments, one of the one or more ports 350 may include an opening dimensioned to receive a monitoring device or sensor (such as a pressure gauge, thermocouple, or similar sensing device). The inspection plate or access plate 320 will have one or more gaskets or O-rings 360 disposed between parts of the inspection plate or access plate 320 and the device shell 315 to provide a pressure-tight seal. The inspection plate or access plate 320 may be fastened to the device shell 315 with a plurality of bolts 370 or other suitable fasteners as would be understood by a person of ordinary skill in the art. The inspection plate or access plate 320 and monitoring port 350 and its connection(s), must meet the same jurisdictional requirements of Codes and/or Standards of the device 300 based on the application of the pressure retaining item.

The one or more ports 350 and inspection plate or access plates 320 provide access to the internal interstitial cavity 335 for post installation ultrasonic thickness monitoring of the encapsulated degraded pressure retaining item pressure boundary area 180. This will allow for beneficial actions including but not limited to continued data capture of the continued rate of degradation of the pressure retaining item. This data could be used and applied to the existing pressure retaining device application or to future device installations (where metal loss rate is factored for establishing future metal loss and metal loss rates for particular erosion/corrosion mechanisms). Inclusion of a monitoring port 350, transparent window 340, or a separate inspection plate or access plate with the device 300 will allow for future observation if and/or when the encapsulated degraded pressure retaining item's pressure boundary material has been breached. The ability to observe the conditions of the encapsulated material may provide the ability to intervene with unforeseen complications associated with the continued degradation of the pressure retaining item wall in the future, before an unforeseen hazardous or costly condition develops. The monitoring port(s) 350 may also provide a mechanism for pressure integrity and structural integrity testing of the device 300 post installation and in current or future service condition of the device 300, as the prior art device 100 (FIG. 1) does not provide for access to the interstitial cavity 335 following installation. The access may be sized to provide for visual inspection of the pressure retaining item internals with or without requiring depressurization of the degraded pressure retaining item system and even provide access for potential future repairs.

The device 300 may be prepared by disposing the hub 110 and shell 315 on the pressure retaining wall 160 in a position where the reduced thickness area 180 and/or the potential breach location 290 are covered by the shell 315 to form the reduced volume cavity or cavities 230, which may remain partially open at this point. The hub 110 is then attached to the wall 160 with the complete joint penetration weld 120. In some embodiments, the optional fillet weld 125 may be applied between the complete joint penetration weld 120 and the wall 160. The inspection plate or access plate 320 may be attached to the opening 316 of the shell 315 and fastened using the bolts 370. The placement of the inspection plate or access plate 320 completes the formation of the cavity 335. In some embodiments, the inspection plate or access plate 320 may be attached prior to the hub 110 being welded to the wall 160.

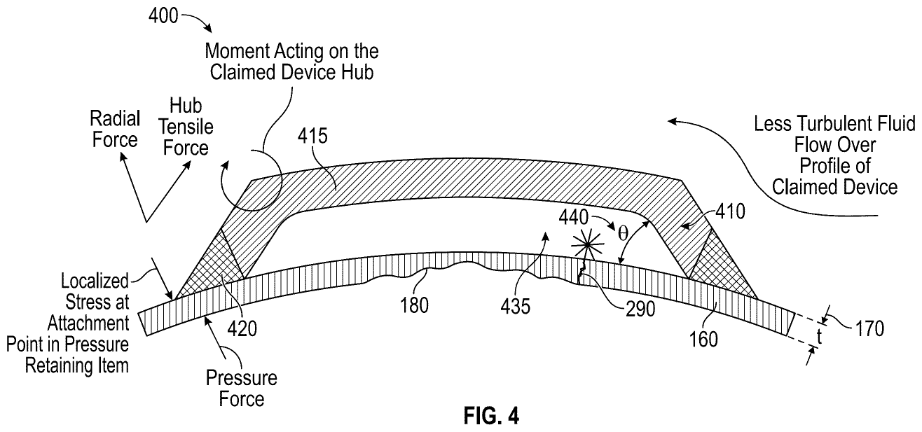

FIG. 4 shows a diagram of a cross-section view of the device 400 dimensioned for attachment to the pressure retaining item wall 160. The device 400 includes a hub 410 similar to the hub or the prior art device's hub 110 (FIG. 1) and a shell 415 similar to the shell 315 according to other embodiments of the present disclosure; however, the hub 410 extends from the pressure retaining item's surface 160 at a non-perpendicular angle, such that the hub 410 forms an acute incident angle 440 with the pressure retaining item wall 160. The resultant weld joint between the device 400 and the pressure retaining item must remain a complete joint penetration fusion weld 420. The angle of incidence 440 may be selected to reduce moment loading and/or discontinuity stresses in the hub 410, device shell 415, and the degraded pressure retaining item wall 160 at and local to where the device 400 is attached to the pressure retaining item wall 160. Moment loading and/or discontinuity stresses which could limit the capacity of the device 400 to serve its restoration purpose are converted to more favorable tensile or compression loading stresses such that the device 400 may be constructed using less hub 410 material thickness and accordingly be lighter, more efficiently installed, and more cost effective. Conversion of the moment loads to more favorable tensile or compression loading (and resultant stresses) may also allow for installation of the device 400 on thinner degraded pressure retaining item pressure boundary wall 160, as said wall will be required to resolve/support less stress state magnitudes. The angle 440 of the hub 410, and essentially the outer profile of the device 400, may also be modified from the previous art device hub 110 (FIG. 1), which is substantially perpendicular to the surface of the degraded pressure retaining item, to an acute incident angle 440 to reduce the effects on the fluid dynamics of the application system. This is beneficial when the device 400 is installed where it will impede flow of a process fluid, either internal or external to the area of degradation on the pressure retaining item 180. An incident angle that is more perpendicular would also be more perpendicular to fluid flow, and therefore cause the device 400 to be more obstructive to flow. In all embodiments of the device 400, the hub 410 must be integrally attached by a complete penetration weld (CJP) 420 to the pressure retaining item wall 160. Similar to other embodiments, the device 400, following installation, will form a cavity 435 where pressure can be maintained, with the device 400 serving as a new or additional pressure boundary.

The device 400 may be prepared by forming the hub 410 and the shell 415 combination with an angle between the parts such that the angle of incidence 440 can be formed between the hub 410 and the wall 160. Then, the hub 410 and shell 415 area may be disposed on the pressure retaining wall 160 in a position where the reduced thickness area 180 and/or the potential breach location 290 are covered by the shell 415 to form the cavity 435. The hub 410 is then attached to the wall 160 with the complete joint penetration weld 420. The angle of incidence 440 may be selected to so as to reduce the turbulence of the fluid flow over the shell 415.

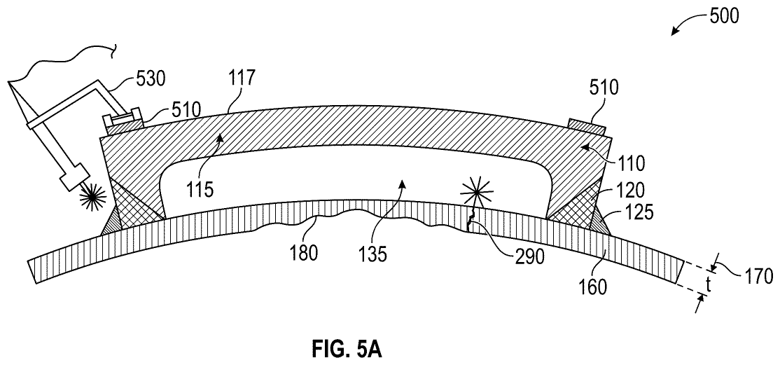

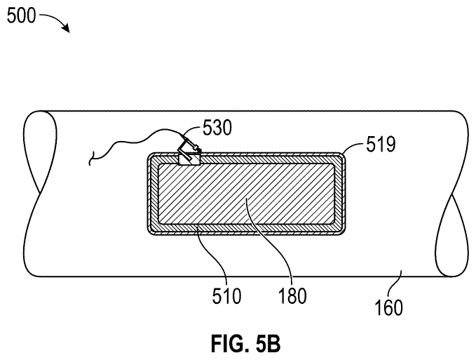

FIG. 5A and FIG. 5B show diagrams of the device 500 similar to the prior art device 100 (FIG. 1) and that includes aspects of the prior art device 100 (FIG. 1). The device 500 also includes a guide track 510 disposed on the outer surface 117 near a perimeter 519 of the device shell 115 for the attachment and guidance of semi-automatic or automated welding equipment 530 (FIG. 5). FIG. 5A shows a cross-section view of the device 500, while FIG. 5B shows a top view of the device 500, so that proximity of the guide track 510 to the perimeter of the device shell 115 may be understood. The guide track 510 may be configured to receive a welding device attachment 530 for automated or semi-automated welding systems. The guide track 510 enables welding personnel to increase speed, accuracy, and consistency of the fusion welding processes used to attach the device 500 to the degraded pressure retaining item. The guide track 510 may be used to improve consistency in the application of weld material between the device's hub 110 and the degraded pressure retaining item's wall 160. Thus, it can be used to reduce installation time and errors in weld quality and application, resulting in higher productivity, reduced costs, and reduced installation risk.

The device 500 may be prepared by disposing the guide track 510 to the perimeter of the outer surface 117 of the shell 115. The hub 110 and the shell 115 are disposed on the pressure retaining wall 160 in a position where the reduced thickness area 180 and/or the potential breach location 290 are covered by the shell 115 to form the reduced volume cavity or cavities 230 The hub 110 is then attached to the wall 160 with the complete joint penetration weld 120. In some embodiments, the optional fillet weld 125 may be applied between the complete joint penetration weld 120 and the wall 160. In some embodiments, the guide track 510 may be applied after the hub 110 is placed on or welded to the wall 160. After the guide track 510 is disposed on the shell 115, the semi-automatic or automatic welding equipment 530 may be mounted on the guide track 510. Then the welding equipment 530 may be moved along the guide track 510 and used to form the reinforcing weld 125 between the weld 120 and the wall 160.

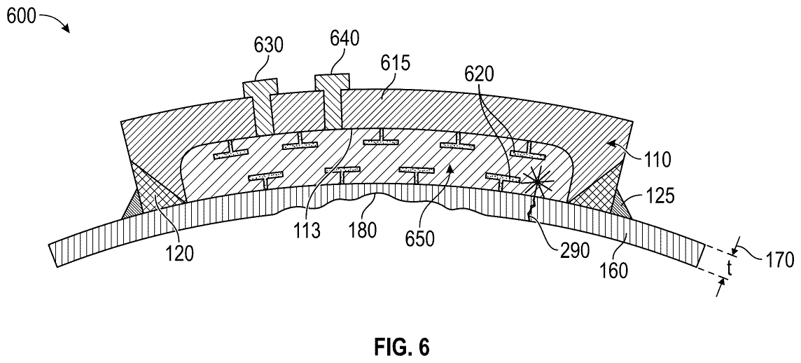

FIG. 6 shows a diagram of a cross-section view of the device 600 installed on a degraded pressure retaining item wall 160 according to another embodiment of the present disclosure. The device 600 includes many of the elements of the prior art device 100 (FIG. 1); however, the interstitial cavity 135 constructed by the installation of the device 600 is filled, or partially filled, with an injectable filler material 650 that is capable of hardening subsequent to injection. The device 600 includes a shell 615 similar to the shell 115; however, the shell 615 may include one or more ports 630 for injection of the filler material 650 into the interstitial cavity 135 and one or more ports 640 for venting of the interstitial cavity 135 to atmosphere during the injection of the filler material 650. The device 600 may also include plugs or bolts (threaded or weld attached) to close the ports 630/640 after the filler material 650 has been injected. The filler material 650 may be selected to reduce corrosion, erosion, thermal leakage, adhesion to the pressure retaining item, or other suitable purposes. A plurality of filler anchors 620 may be disposed in the interstitial space and fastened to one or more of: the inner surface 113 of the device shell 115 and/or the surface of the degraded pressure retaining item wall 160. The filler anchors 620 may be, but are not limited to, welded studs, welded anchorage clips, or an integral machined anchorage geometry on the internal surface 113 of the device shell 115. The filler anchors 620 are employed to mechanically attach the injected filler material 650 to the device shell 115 and/or the outer wall surface of the degraded pressure retaining item wall 160. The filler anchors 620 may also serve as the media to create a rigid bonded connection from the encapsulated degraded pressure retaining devices wall 160 to the inner surface 113 of the device's shell 115.

The presence of the injectable filler material 650 with or without the plurality of filler anchors 620 reduces the risk of large pieces of degraded pressure retaining item wall 160 material dissociating from and falling off of the pressure retaining item and entering the process stream, as the area of degradation 180 continues to degrade. The injectable filler material 650 can also help diffuse or limit the extent of a leak/breach 290 in the degraded pressure retaining item material encapsulated by the device 600, this will reduce the chance of degradation of the device shell 115 due to erosion/corrosion or flow accelerated corrosion. This would help avoid damage to the device 600 from a potential process fluid pressurized jet formed from a leak/breach 290 hole. Further, the injectable filler material 650 may support the deteriorating pressure retaining item wall 160 such that local stress risers associated with a point of breach 290 do not cause material failures (such as cracks) to propagate or otherwise rupture within or beyond the area of the degraded pressure retaining item that is encapsulated. Propagation or rupture could cause catastrophic failure of a pressure retaining device. In some embodiments, the injectable filler material 650 may aide in transfer of load through itself and distribute loading through the device 600, which increases the distribution of loading on the device 600 and reduction of bending moments and/or discontinuity stresses on the device hub 110, the shell 615, and surrounding pressure retaining item material local to the attachment of the device 600, as described in other embodiments of the device 600. As with other embodiments of the device 600 within this disclosure, loading that would otherwise be mostly transferred only through the device 600 is then transferred through the volume of injectable and solidified filler material 650 reducing stress concentrations and bending moments, making the device 600 more capable to serve its pressure retention function. The injectable filler material 650 occupies the interstitial space 135 between the inner surface 113 of the device shell 115 and the degraded pressure retaining item wall 160 and prevents the entrance of process fluid and/or gases into the interstitial cavity 135 in the event of a breach to the original pressure retaining item's wall 160. The injectable filler material 650 can also assist in precluding erosion, corrosion, or flow accelerated corrosion effects on the pressure retention and structural capability of the device 600 as it serves as an additional barrier between process fluids and the material of the device 600. The additional barrier would provide for increased longevity of the device 600. The reduction/elimination of the empty volume within the interstitial cavity 135 also reduces/eliminates potential fluid turbulence within the interstitial cavity 135 in the event of a breach in the original pressure retaining item's wall 160.

The device 600 may be prepared by disposing the filler anchors 620 on the inner side 113 of the shell 115 and/or on the outer surface of the wall 160. Then, the hub 110 and the shell 615 are disposed on the pressure retaining wall 160 in a position where the reduced thickness area 180 and/or the potential breach location 290 are covered by the shell 615. The hub 110 is then attached to the wall 160 with the complete joint penetration weld 120. In some embodiments, the optional fillet weld 125 may be applied between the complete joint penetration weld 120 and the wall 160. After the completion of complete joint penetration weld 120, the injectable filler material 650 is injected through the filler material port 630 to fill the cavity between the hub 110, the shell 615, and the wall 160. In some embodiments, excess filler material may be vented through the vent port 640.

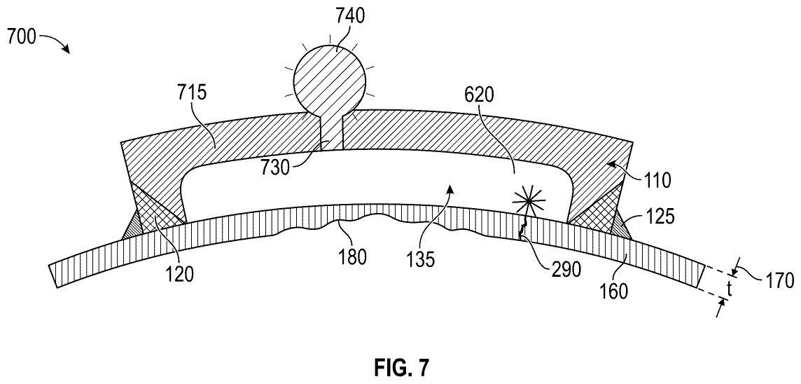

FIG. 7 shows a diagram of a cross-section view of the device 700 with a breach/leak indicator 740, wherein the device 700 is installed on a degraded pressure retaining item wall 160 according to another embodiment of the present disclosure. The device 700 may include similar attributes of the prior art device 100 (FIG. 1), but with a shell 715 similar to the shell 115 that has at least one opening/port 730 dimensioned to receive a breach/leak indicator 740. As with other embodiments of the present disclosure, the installed device 700 along with an installed breach/leak indicator 740 may provide closure to the interstitial cavity 135 when the hub 110 is welded to the pressure retaining item wall 160. The breach/leak indicator 740 may be a pressure gauge, or other monitoring device, either mechanical or electrical, to indicate or detect changes in the interstitial cavity 135 conditions or the presence of process fluid and/or gases within the interstitial cavity 135. This is similar to the inspection plate or access capability described for the device 300 (FIG. 3); however, some indicators may not have the ability to provide inspection or physical access to the interstitial cavity 135 to inspect the pressure retaining item wall 160 of the degraded pressure retaining item encapsulated by the device 700. Further, the device 700 does not require an inspection plate or access plate but can be constructed to have an integral opening/port 730 that may be used for the attachment of a leak/breach indicator 740 to the device shell 715.

The device 700 may be prepared by disposing the hub 110 and the shell 715 (with its opening 730) on the pressure retaining wall 160 in a position where the reduced thickness area 180 and/or the potential breach location 290 are covered by the shell 715 to form the cavity 135. The hub 110 is then attached to the wall 160 with the complete joint penetration weld 120. Then the monitoring device or leak/breach detector 740 is inserted or attached to the opening 730. In some embodiments, the optional fillet weld 125 may be applied between the complete joint penetration weld 120 and the wall 160.

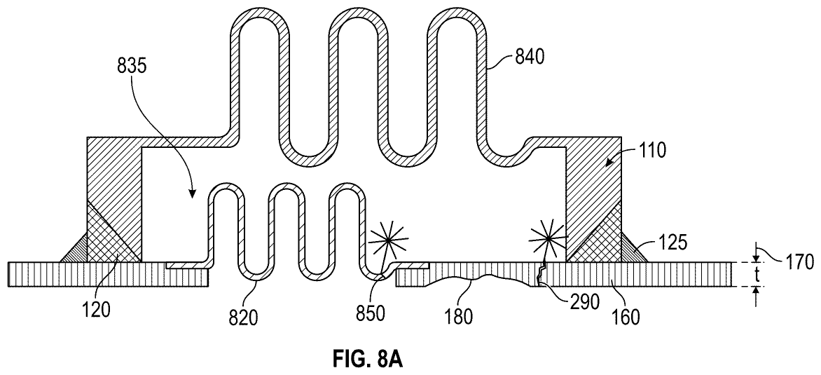

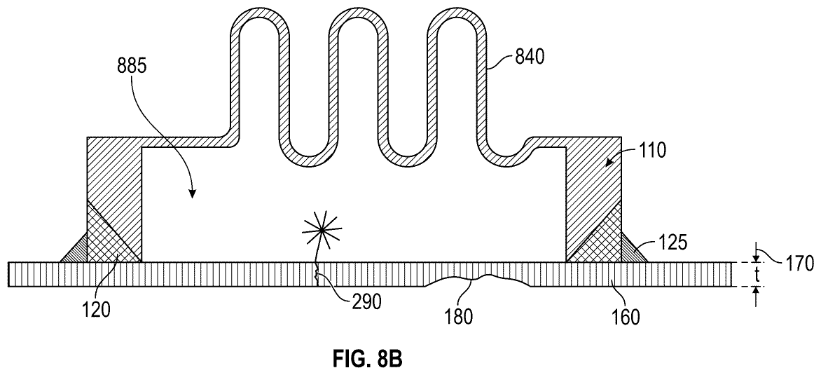

FIG. 8A shows a diagram of a cross-section view of the device 800 on a degraded pressure retaining item wall 160, that also includes an expansion/contraction joint wherein the pressure retaining item wall 160 includes a section 820 that functions as a mechanical (expansion) joint and may have an area of breach/leak 850 and/or degradation 180. The device 800 may include the hub 110 and an expansion joint 840 so that it will provide for required movement flexibility (axial, lateral, or rotational) comparable to the degraded mechanical joint of the pressure retaining item 820. The device 800 may be dimensioned to encapsulate a breached/degraded area of the pressure retaining item's expansion joint 850 and/or a breached/degraded area of the pressure retaining item wall 180, with proximity to the pressure retaining item's expansion joint 820, such that following installation of the device 800, pressure and structural integrity criteria are restored, reestablishing compliance with applicable Codes and Standards. The hub 110, the expansion joint 840, the retaining item wall 160 and the pressure retaining item's expansion joint 820 may form an interstitial space 835. The device hub 110 must be attached to the degraded pressure retaining item wall 160 by complete joint penetration (CJP) weld(s) 120 and associated optional fillet weld(s) 125, where required, such that the device 800 encapsulates the degraded pressure retaining item forming a new pressure boundary. The device's 800 own integral expansion joint 840 then allows for required movement flexibility (axial, lateral, or rotational) of the area of encapsulation and as well as the device 800 in its totality. The device 800 is intended to be employed for the restoration of a pressure retaining item that has an expansion joint (bellows) wherein a leak or degradation has occurred 850 or where a leak or degradation around the area of the existing expansion joint (bellows) requires restoration of the pressure retaining item to maintain its pressure retention, structural capability, and operational function. As with other embodiments of the device within this disclosure, the device 800 produces similar benefits to the process or result of the restoration. The prior art device 100 (FIG. 1) is rigid in nature and does not allow for substantial movement (axial, lateral, or rotational) of the pressure retaining device after installation.

FIG. 8B shows a diagram of a cross-section view of the same device 800 depicted in FIG. 8A; however, it is installed on a rigid degraded pressure retaining item wall 160, similar to the pressure retaining wall 160 in other figures within the present disclosure. The degraded pressure retaining item wall 160 may have a breach/leak 290 and/or a degraded area 180. Here the device 800 is the same as in FIG. 8A; however, it is applied to encapsulate an area of a pressure retaining item that does not have an existing expansion joint 820 as shown in FIG. 8A, and where it is desirable to encapsulate an area of degradation of the pressure retaining item but not impose additional stresses through limiting movement (axial, lateral, or rotational) of the degraded item on which the device 800 is installed. The hub 110, the expansion joint 840, and the retaining item wall 160 may form an interstitial space 885. The integral expansion joint 840 would allow for additional allowed movement (axial, lateral, or rotational) of the encapsulated pressure retaining item, while still establishing a new pressure boundary supplementing or replacing that of the degraded items pressure boundary, and maintaining pressure retention and structural integrity criteria, satisfying requirements of applicable Codes and Standards.

The device 800 may be prepared disposing the hub 110 and the expansion joint 840 on the pressure retaining wall 160 in a position where the reduced thickness area 180 and/or the potential breach location 290 are covered by the expansion joint 840 to form the cavity 835. In some embodiments, the wall 160 may include the expansion joint 820. The hub 110 is then attached to the wall 160 with the complete joint penetration weld 120. In some embodiments, the optional fillet weld 125 may be applied between the complete joint penetration weld 120 and the wall 160.

The foregoing disclosure and description of the disclosure are illustrative and explanatory thereof, and various changes in the details of the illustrated device and system, and the construction and the method of operation may be made without departing from the spirit of the disclosure. Additionally, any device enhancements to the prior art device 100 (FIG. 1) may be made singularly or in plurality as is beneficial to the application.

What is claimed is:

1. A device for encapsulating at least a portion of a pressure retaining item, comprising:
a shell having an inner surface and an outer surface;
a hub proximate to a perimeter of the shell that extends substantially perpendicular from the inner surface, wherein the hub has an edge configured to be integrally attached to the pressure retaining item and surround a portion of the pressure retaining item; wherein the hub is configured to be integrally attached by complete joint penetration (CJP) fusion welding to form a complete coalescence of metal of the hub and the pressure retaining item and form a cavity between the pressure retaining item and the device when integrally attached; and
a filler plate attached to the inner surface of the device.

2. The device of claim 1, wherein the filler plate is configured to not completely fill the cavity when the device is attached to the pressure retaining item.

3. A device for encapsulating at least a portion of a pressure retaining item on one side, comprising:
a shell having an inner surface, an outer surface and an opening; and
a hub proximate to a perimeter of the shell that extends substantially perpendicular from the inner surface, wherein the hub has an edge configured to be disposed integral with the pressure retaining item and surround a portion of the pressure retaining item; wherein the hub is configured to be integrally attached by complete joint penetration (CJP) fusion welding to form a complete coalescence of metal of the hub and the pressure retaining item and form a cavity between the pressure retaining item and the device when integrally attached; and wherein the shell has at least one opening extending from the inner surface to the outer surface.

4. The device of claim 3, further comprising:
at least one of: an inspection plate and an access plate disposed on the outer surface of the shell and covering the opening;
a plurality of bolts configured to fasten the at least one of the inspection plate and the access plate to the shell; and
at least one of an o-ring and a gasket disposed between the shell and the at least one of the inspection plate and the access plate.

5. The device of claim 4, wherein the at least one of the inspection plate and the access plate comprises an inspection window.

6. The device of claim 4, wherein the at least one of the inspection plate and the access plate comprises a physical access port configured to receive a monitoring device.

7. The device of claim 3, wherein the at least one opening comprises a physical access port configured to receive a monitoring device.

8. A device for encapsulating at least a portion of a pressure retaining item on one side comprising:
a shell having an inner surface and an outer surface; and
a raised hub disposed proximate to a perimeter of the shell that extends from the inner surface to an outer surface of the pressure retaining item at an angle of incidence, wherein the hub has an edge configured to be integral with the pressure retaining item and surrounds a portion of the pressure retaining item; wherein the hub is configured to be integrally attached by complete penetration fusion welding to form a complete coalescence of metal of the hub and the pressure retaining item and form a cavity between the pressure retaining item and the device when integrally attached; and wherein the angle of incidence of the hub is not substantially perpendicular to the surface of the pressure retaining item.

9. The device of claim 8, wherein the angle of incidence of the hub is acute.

10. A device for encapsulating at least a portion of a pressure retaining item on one side, comprising:
a shell having an inner surface and an outer surface;
a hub proximate to a perimeter of the shell that extends substantially perpendicular from the inner surface, wherein the hub has an edge configured to be integrated with the pressure retaining item and surround a portion of the pressure retaining item, wherein the hub is configured to be integrally attached by complete penetration fusion welding to form a complete coalescence of metal of the hub and the pressure retaining item and form a cavity between the pressure retaining item and the device; and
a guide track disposed on the outer surface proximate to the perimeter of the pressure maintenance shell and configured to receive one of: an automated welding device and a semi-automated welding device.

11. The device of claim 10, further comprising the one of: the automated welding device and the semi-automated welding device.

12. A device for encapsulating at least a portion of a pressure retaining item on one side comprising:
a shell having an inner surface and an outer surface; and
a hub disposed proximate to a perimeter of the shell that extends substantially perpendicular from the inner surface, wherein the hub has an edge configured to be integrated with the pressure retaining item and surround a portion of the pressure retaining item; wherein the hub is configured to be integrally attached by complete joint penetration (CJP) fusion welding to form a complete coalescence of metal of the hub and the pressure retaining item and form a cavity between the pressure retaining item, the shell, and the hub; and
an injectable filler material disposed in the cavity;
at least two openings in the shell extending between the inner surface and the outer surface; and
at least two caps disposed on the at least two openings.

13. The device of claim 12, further comprising a plurality of filler anchors disposed on at least one of: the inner surface of the pressure maintenance device and the outer surface of the pressure retaining item in the area of encapsulation.

14. The device of claim 12, wherein the filler material is configured to completely fill the cavity between the device and the pressure retaining item.

15. A device for encapsulating a portion of a pressure retaining item on one side comprising:
a shell having an inner surface and an outer surface with a port between the inner surface and the outer surface; and
a hub proximate to a perimeter of the shell that extends substantially perpendicular from the inner surface, wherein the hub has an edge configured to be integral with the pressure retaining item and surround the portion of the pressure retaining item; wherein the hub is configured to be integrally attached by complete joint penetration (CJP) fusion welding to form a complete coalescence of metal of the hub and the pressure retaining item and form a cavity between the pressure retaining item and the device; and
a monitoring device disposed in the at least one port.

16. The apparatus of claim 15, wherein the monitoring device comprises at least one of: a pressure gauge, a temperature sensor, a fluid detector, a pressure activated whistle, and a thickness measuring device.

17. A device for encapsulating at least a portion of a pressure retaining item on one side, comprising:
a shell having an inner surface and an outer surface; and
a hub proximate to a perimeter of the shell that extends substantially perpendicular from the inner surface, wherein the hub has an edge configured to be integral with the pressure retaining item and surround the portion of the pressure retaining item; wherein the hub is configured to be integrally attached by complete joint penetration (CJP) fusion welding to form a complete coalescence of metal of the hub and the pressure retaining item and form a cavity between the pressure retaining item and the pressure maintenance device; and
wherein at least a portion of the shell includes an expansion joint.
